(19) United States
(12) Patent Application Publication
(10) Pub. No.: US 2012/0218447 A1
(43) Pub. Date: Aug. 30, 2012

(54) IMAGE PICKUP APPARATUS

(76) Inventor: Hideyuki FURUYA, Osaka (JP)

(21) Appl. No.: 13/403,056

(22) Filed: Feb. 23, 2012

(30) Foreign Application Priority Data
Feb. 25, 2011 (JP) 2011-039778
Jun. 22, 2011 (JP) 2011-138811

(51) Int. Cl. H04N 9/64

(52) U.S. Cl. 348/246; 348/E05.078

(57) ABSTRACT

An image pickup apparatus including: an image pickup element operable to output an image signal, the image pickup element having a plurality of sensor pixels; a noise pixel extraction unit operable to extract a candidate pixel as a candidate of a pixel that includes sudden noise in a second image signal based on a first image signal captured at a first timing, the second image signal captured at a second timing after the first timing, and a third image signal captured at a third timing after the second timing by the image pickup element; and a correction unit operable to correct a pixel value of at least one candidate pixel in the second image signal extracted by the noise pixel extraction unit.

### BACKGROUND

1. Technical Field

The technical field relates to an image pickup apparatus, and more particularly to an image pickup apparatus capable of detecting sudden noise occurring abruptly and randomly in an image pickup element to correct an image signal.

2. Related Art

Conventionally, there is a problem that high-energy radiant rays from the outer space (cosmic rays) or radiations due to decay of radioactive substances contained in materials composing an image pickup element and other parts disposed nearby impact on a pixel unit so that sudden noise is mixed into an image signal and image quality is degraded. The sudden noise refers to a phenomenon of sudden boost of a signal level of image signals from the pixel on which the radiation impacted and the pixels nearby due to the collision of the radiation. It is the inherent characteristics of sudden noise that it occurs in the image signals from arbitrary number of pixels and belongs to signals of one single frame. In this point, the sudden noise is different from pixel defect (white defect) that always appears in the image signals of frames at a specific pixel(s).

In the future, when miniaturization of a semiconductor process advances and a pixel pitch becomes smaller (1 μm or less), it is concerned that pixels at which sudden noise occur increases.

There is a tendency, in consumer products which are not intended to be used for imaging mainly (mobile telephones, portable music players, electronic book viewers and the like), that inexpensive materials that include comparatively large amount of radioactive substances are used in an image pickup elements and peripheral parts in order to reduce the costs. In such products, since the image pickup elements receive a comparatively lot of radial rays, the sudden noise might occur at a high incidence rate.

JP 2009-5083A discloses a method for detecting sudden noise included in an image signal. In the method of JP 2009-5083A, a pixel(s) of which signal level in the image signals of one frame image is higher than a predetermined threshold is extracted.

Then, it is checked whether a predetermined number of the extracted pixels or more continue in one direction or not and, based on the checking, the sudden noise is detected. More exactly, in the method of JP 2009-5083A, an image pickup element 501 executes a photoelectric converting process to convert incident light (light signal) from a subject into an electric signal (image signal), and outputs the image signal to a median filter 502 as shown in FIG. 8. The median filter 502 executes a median filtering process onto the image signal so as to remove defective pixels (white defects), and outputs the image signal to an address extractor 503 and a frame delay 505. The address extractor 503 extracts pixels where a signal level of an image signal is higher than a predetermined threshold, obtains addresses of the extracted pixels, and outputs the addresses of the extracted pixels to an extracted pixels determinator 504. The extracted pixels determinator 504 checks based on the addresses of the extracted pixels whether a predetermined number or more of the extracted pixels continue in one direction. When the predetermined number or more of the extracted pixels continue in one direction, the extracted pixels determinator 504 recognizes that the extracted pixels are pixels where the sudden noise occurs, obtains the addresses of the recognized pixels, and outputs the addresses to an adjacent pixel compensator 506.

The frame delay 505 delays an image signal by one frame using a frame memory in order to secure a time required for the detection of sudden noise and outputs the image signal to the adjacent pixel compensator 506. The adjacent pixel compensator 506 compensates pixels where the sudden noise has occurred using a signal of the pixel that is adjacent to the pixel where the sudden noise has occurred based on the addresses of the recognized pixels so as to eliminate the sudden noise and outputs the image signal to a signal processing circuit 507. The signal processing circuit 507 executes various types of necessary processes for the image pickup apparatus so as to output the image signal.

However, the sudden noise sometimes appears as a comparatively low signal level within an image signal, or the sudden noise sometimes occurs in a plurality of pixels included in a two-dimensionally wide area (oblong/trapezoidal). In the above conventional method, the sudden noise emerging in the above mentioned manner is not assumed, and thus, such sudden noise cannot be detected.

### SUMMARY

The problem in the related art considered, an image pickup apparatus that can accurately detects sudden noise of various signal levels and various shapes.

A first aspect provides an image pickup apparatus. The image pickup apparatus includes: an image pickup element operable to output an image signal, the image pickup element having a plurality of sensor pixels; a noise pixel extraction unit operable to extract a candidate pixel as a candidate of a pixel that includes sudden noise in a second image signal based on a first image signal captured at a first timing, the second image signal captured at a second timing after the first timing, and a third image signal captured at a third timing after the second timing by the image pickup element; and a correction unit operable to correct a pixel value of at least one candidate pixel in the second image signal extracted by the noise pixel extraction unit.

A second aspect provides a processor. The processor includes: a noise pixel extraction unit operable to input a first image signal, a second image signal, and a third image signal and extract a candidate pixel as a candidate of a pixel that includes sudden noise in the second image signal based on the first image signal, the second image signal, and the third image signal. The first, second, and third image signals are captured by an image pickup element having a plurality of sensor pixels. The first image signal is captured at a first timing. The second image signal being captured at a second timing after the first timing. The third image signal being captured at a third timing after the second timing.

A third aspect provides an imaging method. The method includes: inputting a first image signal captured at a first timing, a second image signal captured at a second timing after the first timing, and a third image signal captured at a third timing after the second timing by an image pickup element having a plurality of sensor pixels; extracting a candidate pixel as a candidate of a pixel that includes sudden noise in the second image signal based on the first image signal, the second image signal, and the third image signal; and correcting a pixel value of at least one candidate pixel in the second image signal extracted at the extracting.

A fourth aspect provides a computer-readable medium. The medium includes computer executable instructions. When the instructions are executed by a computer, the computer is caused to perform: inputting a first image signal captured at a first timing, a second image signal captured at a second timing after the first timing, and a third image signal captured at a third timing after the second timing by an image pickup element having a plurality of sensor pixels; extracting a candidate pixel as a candidate of a pixel that includes sudden noise in the second image signal based on the first image signal, the second image signal, and the third image signal; and correcting a pixel value of at least one candidate pixel in the second image signal extracted at the extracting.

In the aspects, sudden noise is detected based on a sudden noise detection frame and frames captured (imaged) before or after the sudden noise detection frame with regard to imaging timing, so that, the sudden noise occurring randomly without reproducibility can be detected accurately.

### BRIEF DESCRIPTION OF DRAWINGS

FIG. 1 is a diagram describing a sudden noise phenomenon;

FIG. 2 is a block diagram of a configuration of an image pickup apparatus according to a first embodiment;

FIG. 3 is a schematic diagram of a pixel arrangement of the image pickup element according to the first embodiment;

FIG. 4 is a flowchart of processes of the image pickup apparatus according to the first embodiment;

FIG. 5A is a diagram of first pixel subtraction data generated by the image pickup apparatus according to the first embodiment;

FIG. 5B is a diagram of second pixel subtraction data generated by the image pickup apparatus according to the first embodiment;

FIG. 5C is a diagram of candidate pixels data generated by the image pickup apparatus according to the first embodiment;

FIG. 5D is a diagram of sudden noise generating pixels data generated by the image pickup apparatus according to the first embodiment;

FIG. 6 is a schematic diagram illustrating the adjacent pixels of the first embodiment;

FIG. 7 is a block diagram of a configuration of an image pickup apparatus according to a second embodiment; and

FIG. 8 is a block diagram of a configuration of a conventional image pickup apparatus.

### DETAILED DESCRIPTION OF PREFERRED EMBODIMENTS

Hereinafter, embodiments are described in detail with reference to the drawings.

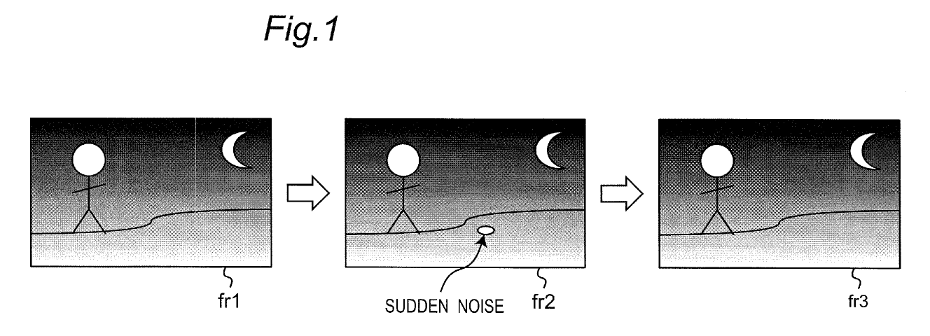

First, sudden noise will be described with reference to FIG. 1. FIG. 1 is a schematic diagram illustrating sudden noise appeared in an image picked up by an image pickup apparatus.

A frame fr1, a frame fr2, and a frame fr3 are image frames captured (imaged) continuously in this order. Sudden noise appears only in the frame fr2, but is not observed in the frame fr1 and the frame fr3, both of which are contiguous with the frame fr2 along the imaging timing.

As described above, sudden noise occurs abruptly and appears only in one frame. Sudden noise is caused by a collision between a pixel(s) of an image pickup element and a radiation, which is generated when radioactive substances included in materials of parts of the image pickup element decay or comes from the outside. Sudden noise may occur and appear from one pixel to dozens of pixels owing to the intensity of the colliding radiation. A shape of the appearance of sudden noise varies depending on an incident angle of the incoming radiation with respect to the image pickup element. A level of the signal outputted from the pixel(s) that has collided with a radiation (a level of luminosity (brightness) of the sudden noise) varies depending on an amount of energy that has been given to the pixel(s) of the image pickup element when the radiation collides with the pixel(s). Consequently, the signal level of sudden noise, the number of pixels where sudden noise occurs (the size of a noise generating area), and a shape of the area where the sudden noise occurs vary randomly, i.e., without regularity. That is to say, sudden noise with diverse luminosities, sizes, and/or shapes occurs abruptly and appears only in a certain one frame, but does not appear in the frames before and after this certain one frame with respect to imaging timing.

The image pickup apparatus according to the embodiments can accurately detect the above mentioned sudden noise. The image pickup apparatus compares an image signal of a sudden noise detection frame (a target frame) with image signals of other frames (reference frames), which are positioned before and after the target frame with respect to imaging timing. Then, the image pickup apparatus extracts a candidate pixel(s) where the sudden noise is likely to occur from the target frame based on a result of the comparison so as to detect the sudden noise.

According to the structure as such, the image pickup apparatus according to the embodiments can accurately detect sudden noise of various shapes, sizes, and luminosity.

### 1. FIRST EMBODIMENT

### 1-1. Configuration

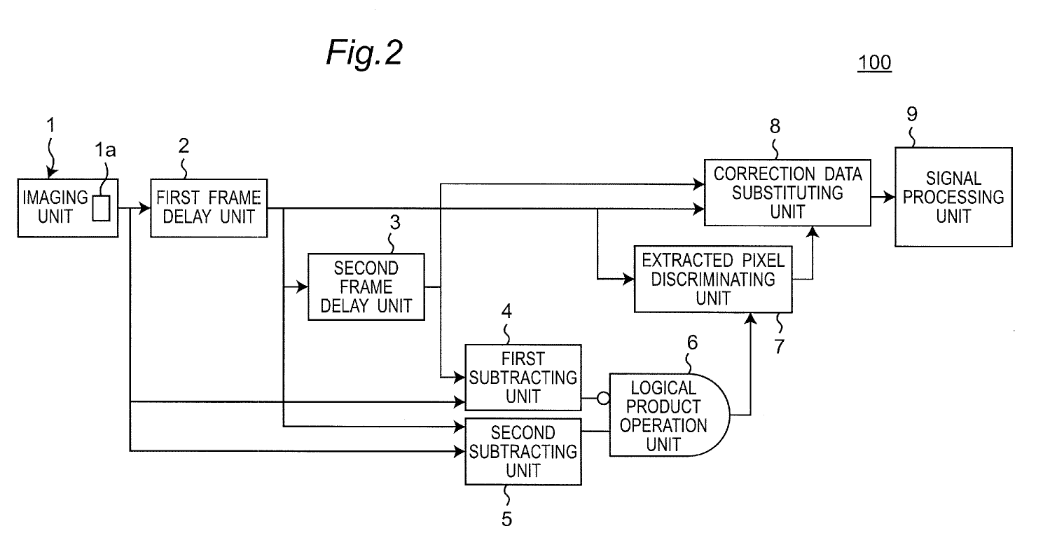

FIG. 2 is a block diagram of a configuration of an image pickup apparatus 100 according to the first embodiment. The image pickup apparatus 100 includes: an imaging unit 1 having an image pickup element 1a; a first frame delay unit 2; a second frame delay unit 3; a first subtracting unit 4; a second subtracting unit 5; a logical product operation unit 6; an extracted pixel discriminating unit 7; a correction data substituting unit 8; and a signal processing unit 9.

The imaging unit 1 has an optical system (not shown) and the image pickup element 1a. The optical system includes an objective lens, a zoom lens, a diaphragm, an Optical Image Stabilizer (OIS) unit and a focus lens. The optical system collects light from a subject, and forms a subject image on the image pickup element 1a. The image pickup element 1a is composed of a plurality of pixels (sensor pixels). The image pickup element 1a outputs pixel values, each of which corresponds to the intensity of the light received by each sensor pixel. The imaging unit 1 generates an image signal of the subject image based on these pixel values. A CCD image sensor, a CMOS image sensor, etc. are examples of the image pickup element 1a.

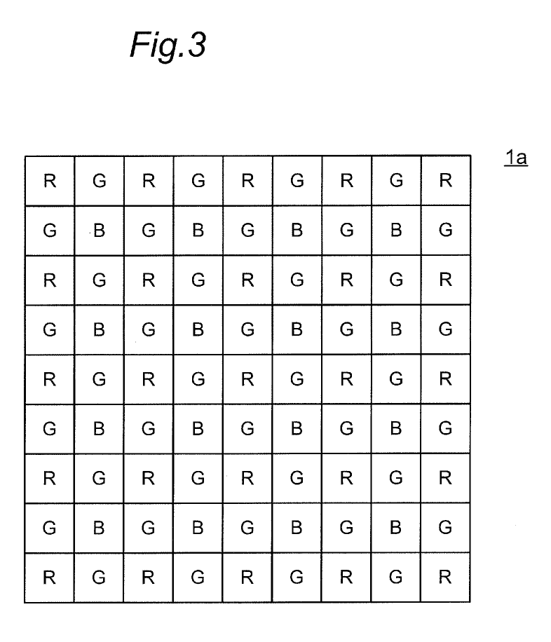

The image pickup apparatus 100 according to the first embodiment has a single-chip type image pickup element as the image pickup element 1a. In FIG. 3, an example of an arrangement of pixels of such a single-chip type image pickup element is illustrated. Color filters are regularly arranged (in the Bayer arrangement, for example,) on a surface of the image pickup element 1a of FIG. 3, and each sensor pixel of the image pickup element 1a outputs a pixel value of a channel R (Red), G (Green), or B (Blue) as a channel signal.

In such a single-chip type image pickup element 1a, except for a case where a subject of a particular color is captured, a level (a pixel value) of a channel signal that is output from a certain sensor pixel of interest is generally different from a level (a pixel value) of a channel signal of another color that is output from another sensor pixel which is adjacent to the sensor pixel of interest and senses (is sensitive to, responds to) light of another color. In the case where a white colored subject is captured under the illumination of a color temperature of 3200 K, for example, signal levels (pixel values) of channel signals of respective colors that are output from neighbor sensor pixels are higher in order from a G (green) channel, a R (red) channel, to a B (blue) channel, and the level of the G channel image signal is four times as high as that of the B channel image signal.

On the other hand, since radiations have strong penetrating power, radiations being incident on the image pickup element la are not blocked by the color filters and reach the image pickup element 1a. Accordingly, even if adjacent sensor pixels in the image pickup element 1a are covered with filters of different colors, signal levels (pixel values) induced due to a collision of a radiation have equivalent levels. Consequently, in the case where a certain sensor pixel and another sensor pixel adjacent to the certain one, i.e., another sensor pixel that receives the light from a subject substantially identical with that the certain one receives, output equivalent channel signals (pixel values) of different colors with respect to their levels, it is very highly likely that the sudden noise should occur at the certain and adjacent sensor pixels.

As already mentioned above, the sudden noise occurs abruptly and appears with a variety of luminosity, sizes and shapes only in one frame, but does not appear in the frames before and after that frame with respect to imaging timing.

Therefore, in the first embodiment, an image signal of a target frame is compared with image signals of reference frames that are located before and after the target frame with respect to imaging timing to detect, in the target frame, a candidate pixel where sudden noise is likely to occur and a pixel value of the detected pixel is corrected. Further, in the first embodiment, in order to enhance the accuracy of sudden noise detection, a pixel value is referred to so that it is determined whether or not the pixel value has an equivalent level with a pixel value of a candidate pixel value. The pixel value referred to is a pixel value output from a sensor pixel that is located near a sensor pixel outputting the pixel value of the candidate pixel and senses light of a different color than the color which the sensor pixel outputting the pixel value of the candidate pixel senses. By doing so, occurrence/non-occurrence of sudden noise at the candidate pixel can be determined more accurately.

The imaging unit 1 captures a subject image and outputs an image signal of one frame to the first frame delay unit 2, the first subtracting unit 4 and the second subtracting unit 5. The image signal includes channel signals (pixel values) output from the respective sensor pixels of the image pickup element 1a.

The first frame delay unit 2 delays the image signal output from the imaging unit 1 by one frame, and then, outputs the delayed image signal to the correction data substituting unit 8, the second frame delay unit 3 and the second subtracting unit 5. Here, the one frame refers to an image signal including channel signals (pixel values) for an image of one frame. The one frame delay means buffering an image signal of one frame and outputting the buffered image signal at the timing when the imaging unit 1 outputs the image data of next frame. The buffered image signal may not be output at timing precisely synchronized with the timing when the imaging unit 1 outputs image data.

The second frame delay unit 3 further delays the image signal input from the first frame delay unit 2 by one frame, and then, outputs the further delayed image signal to the correction data substituting unit 8 and the first subtracting unit 4.

Please note that the first frame delay unit 2 and the second frame delay unit 3 may be configured using a frame memory etc.

Thus, the first subtracting unit 4 inputs an image signal (a third image signal) and an image signal (a first image signal), both of which are captured by the imaging unit 1, and the first image signal is the signal that has been captured two frames before the third image signal is captured with respect to the imaging timing. Similarly, the second subtracting unit 5 inputs an image signal (the third image signal) and an image signal (a second image signal), which are captured by the imaging unit 1, and the second image signal is the signal that has been captured one frame before the third image signal is captured with respect to the imaging timing. Now the second image signal is an image signal of a sudden noise detection frame (a target frame), and the first image signal and the third image signal are image signals of frames (reference frames) lined before and after the target frame along the imaging timing. It should be noted that, although the reference frames are the frames immediately before and after the target frame in the following description, the reference frames may include a frame captured prior to the target frame with respect to imaging timing and a frame captured posterior to the target frame with respect to imaging timing.

The first subtracting unit 4 inputs an image signal input directly from the imaging unit 1 (an image signal which has not undergone the frame delay (the third image signal)) and an image signal output from the second frame delay unit 3 (an image signal which has undergone the frame delay twice (the first image signal)). The first subtracting unit 4 performs pixel basis (pixel-by-pixel) subtraction between those image signals, and, based on the subtraction result, generates first pixel subtraction data described later and outputs the data to the logical product operation unit 6. Here, the subtraction may be subtraction operation between a pixel value of a pixel included in the first image signal and a pixel value of a pixel that is included in the third image signal and lies on the same position as the first image signal's pixel concerned. In other words, in terms of the output from each sensor pixel of the image pickup element 1a, subtraction between an output value for the first image signal and an output value for the third image signals is performed in the subtraction operation here.

The first subtracting unit 4 outputs data for one frame (the first pixel subtraction data), in which a datum of “1” (High) is recorded for a pixel where the difference between the pixel values in the first and the third image signals (absolute value) is equal to or greater than a first threshold value, and a datum of “0” (Low) is recorded for a pixel where the difference between the pixel values in the first and the third image signals (absolute value) is less than the first threshold value. The first threshold is a threshold value that is set in advance, and is held by the first subtracting unit 4. It is preferable that the first threshold value is set so as to be slightly larger than amplitude of random noise occurring in the image pickup element 1a. In short, the datum of “1” is recorded for the pixel that has significantly changed between the first and the third image signals, and the datum of “0” is recorded for the pixel that has not changed therebetween.

The second subtracting unit 5 inputs an image signal input directly from the imaging unit 1 (an imaging signal which has not undergone the frame delay (the third image signal)) and an image signal output from the first frame delay unit 2 (an image signal which has undergone the frame delay once (the second image signal)). The second subtracting unit 5 performs pixel basis subtraction between those image signals, and, based on the subtraction result, generates second pixel subtraction data described later and outputs the data to the logical product operation unit 6. Similarly to the subtraction operation by the first subtracting unit 4, this subtraction may also be subtraction operation between a pixel value of a pixel included in the second image signal and the pixel value of the pixel in the same position in the third image signal. That is to say, regarding the output of the respective sensor pixels in the image pickup element 1a, subtraction operations are performed between the output values in the second image signal and the output values in the third image signal.

The second subtracting unit 5 can use the first image signal instead of the third image signal to obtain the difference from the second image signal.

The second subtracting unit 5 outputs data for one frame (the second pixel subtraction data), in which a datum of “1” (High) is recorded for a pixel where the difference between the pixel values in the second and third image signals (absolute value) is equal to or greater than a second threshold value, and a datum of “0” (Low) is recorded for a pixel where the difference between the pixel values (absolute value) is less than the second threshold value. The second threshold is a threshold value that is set in advance, and is held by the second subtracting unit 5. The second threshold may be the same as or different from the first threshold. It is preferable that the second threshold value is also set so as to be slightly larger than the amplitude of random noise occurring in the image pickup element 1a. In short, the datum of “1” is recorded for the pixel that has significantly changed between the second and the third image signals, and the datum of “0” is recorded for the pixel that has not changed therebetween.

The logical product operation unit 6 inputs the first pixel subtraction data output from the first subtracting unit 4 and the second pixel subtraction data output from the second subtracting unit 5. The logical product operation unit 6 generates and outputs data for one frame (candidate pixel data), in which a datum of “1” (High) for pixels where the value in the first pixel subtraction data is “0” and the value in the second pixel subtraction data is “1” and a datum of “0” (Low) for the other pixels where the values in the first and second pixel subtraction data do not match the above mentioned condition are recorded. In other words, the datum of “1” is recorded on the pixel where the pixel values thereof does not significantly change between the first image signal and the third image signal and significantly change between the second image signal and the third image signal, and the datum of “0” is recorded on the other pixel. The pixel where the datum of “1” is recorded is a pixel (“candidate pixel”) where the sudden noise has likely occurred in the second image signal.

The extracted pixel discriminating unit 7 constitutes a noise pixel determining unit that determines whether each of the candidate pixels includes sudden noise or not with more accuracy. The extracted pixel discriminating unit 7 inputs therein the candidate pixel data output from the logical product operation unit 6 and the image signal (the image signal delayed by one frame (the second image signal)) output from the first frame delay unit 2. The extracted pixel discriminating unit 7 determines whether the second image signal includes sudden noise on the candidate pixels or not based on the candidate pixel data and the second image signal. The methodology for determining will be described later. Then, the extracted pixel discriminating unit 7 outputs data for one frame (sudden noise generating pixel data), in which a datum of “1” (High) is recorded for the pixel that is determined that the sudden noise has occurred and a datum of “0” (Low) is recorded for the pixel that is determined that the sudden noise has not occurred.

As to the pixel that has the datum of “1” (High) in the sudden noise generating pixel data output from the extracted pixel discriminating unit 7, the correction data substituting unit 8 replaces the pixel value of the second image signal (the image signal delayed by one frame) output from the first frame delay unit 2 with the pixel value of the corresponding pixel of the first image signal (image signal delayed by two frames) output from the second frame delay unit 3. The correction data substituting unit 8 corrects a pixel value of the pixel which has been determined by the extracted pixel discriminating unit 7 that the sudden noise has occurred thereon among the candidate pixels in the second image signal. The correction data substituting unit 8 may operate so as not to correct the value of the pixel which has been determined as not including sudden noise by the extracted pixel discriminating unit 7 within the candidate pixels of the second image signal.

The signal processing unit 9 executes various necessary image processes for the image pickup apparatus 100 such as gamma correction, white balance correction, scratch correction, etc. on the image signal output from the correction data substituting unit 8, and outputs the image signal.

### 1-2. Operations

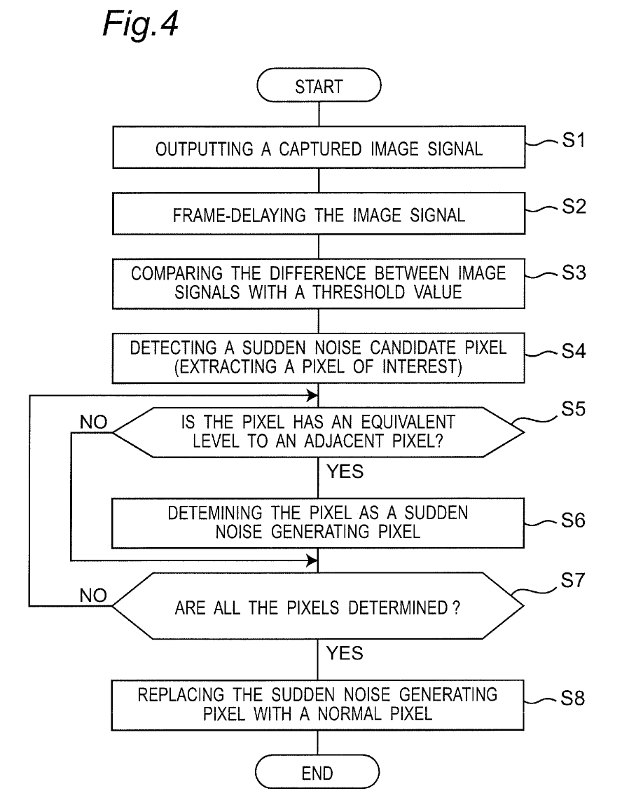

An operation of the image pickup apparatus 100 having the above configuration will be described with reference to a flowchart in FIG. 4.

The imaging unit 1 outputs a signal including a pixel value output from each pixel of the image pickup element 1a as the third image signal (a signal of a reference frame imaged after the target frame with regard to the imaging timing) to the first subtracting unit 4, the second subtracting unit 5 and the first frame delay unit 2 (S1).

The first frame delay unit 2 outputs an image signal which has been output from the imaging unit 1 and delayed by one frame (a second image signal, namely, a signal of the target frame) to the correction data substituting unit 8, the second subtracting unit 5, and the second frame delay unit 3. The second frame delay unit 3 outputs a first image signal which has been output from the imaging unit 1 and delayed by two frames (a signal of the reference frame imaged before the target frame with regard to the imaging timing) to the correction data substituting unit 8 and the first subtracting unit 4 (S2).

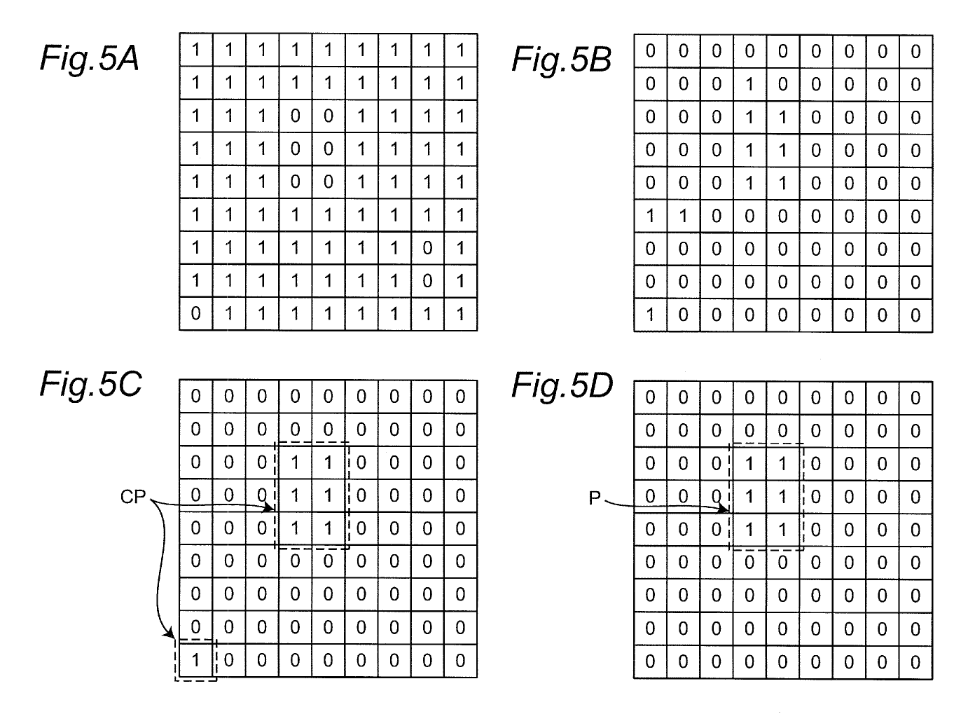

The first subtracting unit 4 performs subtraction operations between the third image signal (the reference frame imaged after the target frame) and the first image signal (the reference frame imaged before the target frame) pixel by pixel. The first subtracting unit 4 compares the subtraction result with the first threshold value so as to output data of one frame (the first pixel subtraction data) to the logical product operation unit 6 (S3). FIG. 5A illustrates an example of the data of one frame (the first pixel subtraction data) output from the first subtracting unit 4.

The second subtracting unit 5 performs the pixel-by-pixel subtraction operations between the third image signal (the reference frame imaged after the target frame) and the second image signal (the target frame). The second subtracting unit 5 compares the subtraction result with the second threshold value, and outputs data of one frame (the second pixel subtraction data) to the logical product operation unit 6 (S3). FIG. 5B illustrates an example of the data of one frame (the second pixel subtraction data) output from the second subtracting unit 5.

The logical product operation unit 6 constitutes the noise pixel extraction unit which extracts a pixel (a candidate pixel) where sudden noise have likely occurred. The logical product operation unit 6 generates and outputs data for one frame (candidate pixel data), in which a datum of “1” (High) for pixels where the value in the first pixel subtraction data is “0” and the value in the second pixel subtraction data is “1” and a datum of “0” (Low) for the other pixels where the values in the first and second pixel subtraction data do not match the above mentioned condition are recorded (S4). FIG. 5C illustrates an example of the data for one frame (the candidate pixel data) output from the logical product operation unit 6 The pixel where the data “0” (Low) is recorded in the candidate pixel data (pixels CP in FIG. 5C) is the pixel where the sudden noise has likely occurred caused (candidate pixel). The candidate pixel is the pixel where the difference between the pixel values of the two reference frames is smaller than the first threshold value and the difference between the pixel values of the target frame and a reference frame is greater than the second threshold value.

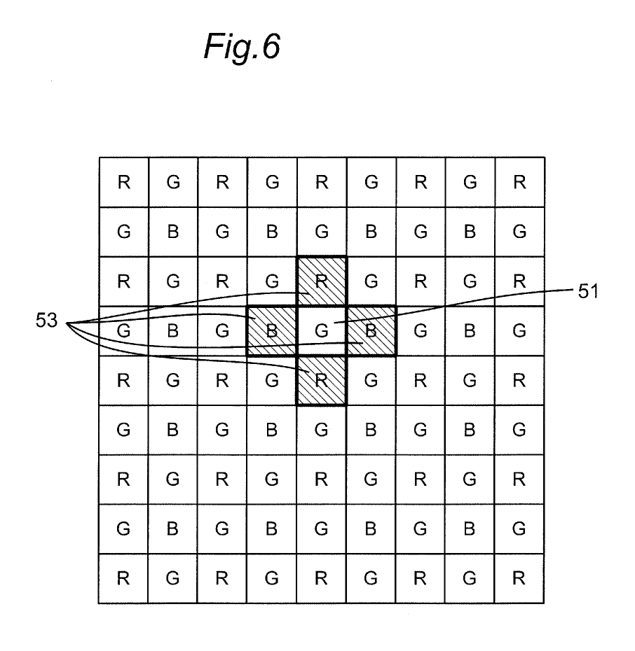

The extracted pixel discriminating unit 7 compares the pixel value of the pixel (the candidate pixel) in the target frame (the second image signal) where the datum of “1” (High) is recorded in the data for one frame (the candidate pixel data) output from a logical product operation unit 206 with the pixel value of a pixel adjacent to the candidate pixel in the target frame (S5). In short, at this step, the pixel value of the candidate pixel is compared with a pixel value output from a sensor pixel that receives subject light substantially identical to that received by the sensor pixel of the candidate pixel and is sensitive to light of a different color from that the image pickup element outputting the pixel value of the candidate pixel senses (see FIG. 3 and FIG. 6).

The extracted pixel discriminating unit 7 compares the pixel value of the candidate pixel in the target frame with the pixel value of the pixel adjacent to the candidate pixel in the target frame (S5). When at least one adjacent pixel where the difference (absolute value) therebetween is within a third threshold is present (“YES” at step S5), the data value of the pixel in the candidate pixel data is maintained at “1” (High), and when no adjacent pixel where the difference (absolute value) is within the third threshold is present (“NO” at step S5), the data value of the pixel in the candidate pixel data is changed into “0” (Low). The third threshold value is a threshold that is set in advance, and is held in the extracted pixel discriminating unit 7. The third threshold is preferably adjusted so that the sudden noise should not be overcorrected.

The candidate pixel whose data value is maintained at “1” is the pixel that has been determined as that the sudden noise has occurred, and the candidate pixel whose data value is changed into “0” is the pixel that has been determined as that the sudden noise has not occurred. The determination here employs the characteristics of sudden noise such that when sudden noise occurs, the pixel values of the adjacent pixels have equivalent level to each other regardless of their color channels.

FIG. 6 is a diagram describing the adjacent pixels mentioned above. When a pixel 51 is assumed to be a candidate pixel, the adjacent pixels are the four pixels 53 adjacent to the pixel 51 up, down, right and left. When the candidate pixel 51 is the G channel, the adjacent pixels 53 may have different color channels. In the case of a normal subject without sudden noise, as described above, the pixel values of different color channels vary on the adjacent pixels, but when sudden noise occurs, the signal levels are equal to each other even if the adjacent pixels have different color channels. The extracted pixel discriminating unit 7 uses this characteristic to detect presence/non-presence of sudden noise on the candidate pixels.

When the determinations at step S5 and step S6 for all the candidate pixels represented in the candidate pixel data are completed (“YES” at step S7), the extracted pixel discriminating unit 7 outputs data for one frame (the sudden noise generating pixel data) to the correction data substituting unit 8, In which a datum of “1” (High) is recorded on the pixel that has been determined that the sudden noise has occurred and a datum of “0” (Low) is recorded on the pixel that has been determined that the sudden noise has not occurred. FIG. 5D illustrates an example of the data for one frame (the sudden noise generating pixel data) output from the extracted pixel discriminating unit 7. In this figure, it is determined that the sudden noise has occurred on the pixel P at the center among the candidate pixels CP of FIG. 5C.

As to the target frame (the second image signal), the correction data substituting unit 8 replaces the pixel value of the pixel where the sudden noise has occurred with the pixel value of the corresponding pixel in the reference frame (the third image signal) based on the sudden noise generating pixel data output from the extracted pixel discriminating unit 7 (S8). As a result, the sudden noise included in the image signal (the second image signal) that is delayed by one frame can be removed.

The correction data substituting unit 8 replaces the pixel value of the target frame with the pixel value of the reference frame based on the sudden noise generating pixel data. Alternatively, based on the candidate pixel data, the pixel value of the target frame may be replaced with the pixel value of the reference frame. By this, a reduction in a processing load, speeding-up of a processing speed, and a reduction in a power consumption can be expected.

In this embodiment, the correction data substituting unit 8 replaces the image signal of the pixel where the sudden noise has occurred with the two frame delayed image signal of the pixel in the same position (the third image signal). However, it may be replaced with the image signal of the pixel in the same position without a delay (the first image signal).

In this embodiment, the first subtracting unit 4 calculates a difference between the image signal with no delay (the third image signal) and the image signal delayed by two frames (the first image signal). The second subtracting unit 5 calculates a difference between the image signal with no delay (the third image signal) and the image signal delayed by one frame (the second image signal). The logical product operation unit 6 assigns a data value “1” (High) to the pixels where the value of the first pixel subtraction data output from the first subtracting unit 4 is “0” (Low) and the value of the second pixel subtraction data output from the second subtracting unit 5 is “1” (High), and assigns a data value “0” (Low) to the other pixels so that the candidate pixel data for one frame is generated and output. However, embodiments are not limited to the configuration above.

The first subtracting unit 4 may calculate a difference between the image signal (the second image signal as the target frame) delayed by one frame and the image signal (the first image signal as the reference frame) delayed by two frames. The second subtracting unit 5 may calculate a difference between the image signal (the third image signal as the reference frame) without a delay and the image signal (the second image signal as the target frame) delayed by one frame. The logical product operation unit 6 may assign the data value “1” (High) to the pixels where the value of the first pixel subtraction data output from the first subtracting unit 4 is “1” (High) and the value of the second pixel subtraction data output from the second subtracting unit 5 is “1” (High), and assign the data value “0” (Low) to the other pixels so that the logical product operation unit 6 may generate and output the candidate pixel data for one frame.

In the image pickup apparatus 100 according to the present embodiment, the sudden noise that occurs without reproducibility and appears over a plurality of pixels in the single-chip type image pickup element 1a can be accurately removed, and a satisfactory image can be obtained.

The image pickup apparatus 100 may not have the extracted pixel discriminating unit 7. In this case, the correction data substituting unit 8 may recognize the pixel where the data value “1” is recorded in the candidate pixel data output from the logical product operation unit 6 as the pixel including sudden noise and correct an image.

Detailed configurations and detailed operations of the respective components forming the image pickup apparatus 100 according to the first embodiment can be suitably modified without deviating the scope of the present invention.

### 2. SECOND EMBODIMENT

A second embodiment will be described below with reference to the drawings.

The first embodiment uses a single-chip type image pickup element, in which color filters are regularly arranged on the surface of the image pickup element 1a (Bayer arrangement etc.). The second embodiment, however, uses a three-element type (triple-chip type) image pickup element. Subject light is dispersed into three colors by a prism, and, then, the dispersed light is incident on a plurality of image pickup elements, respectively.

In the three-element type image pickup element, an image pickup element of a certain color channel is physically separated from an image pickup element of another color channel, both of which receive substantially identical subject light.

For this reason, sudden noise that occurs due to the incidence of radial rays is always occurs only on the image pickup element of one color channel (for example, R). Therefore, in the case where the three-element type image pickup element is used, candidate pixels (pixels where the sudden noise is suspected to occur) are extracted for respective color channels similarly to the first embodiment, and, then, as to the sensor pixels of another color channels that receive the subject light substantially identical to that the candidate pixels receive, presence/non-presence of a change of pixel value between the target frame and the reference frame is checked. (It is checked whether the pixels of another color channels are also candidate pixels or not.) By this, it is determined whether sudden noise has occurred on the candidate pixels or not. The sudden noise can be detected based on the determination result. For this reason, the detection of sudden noise is comparatively simpler than the case of the single-chip type image pickup element.

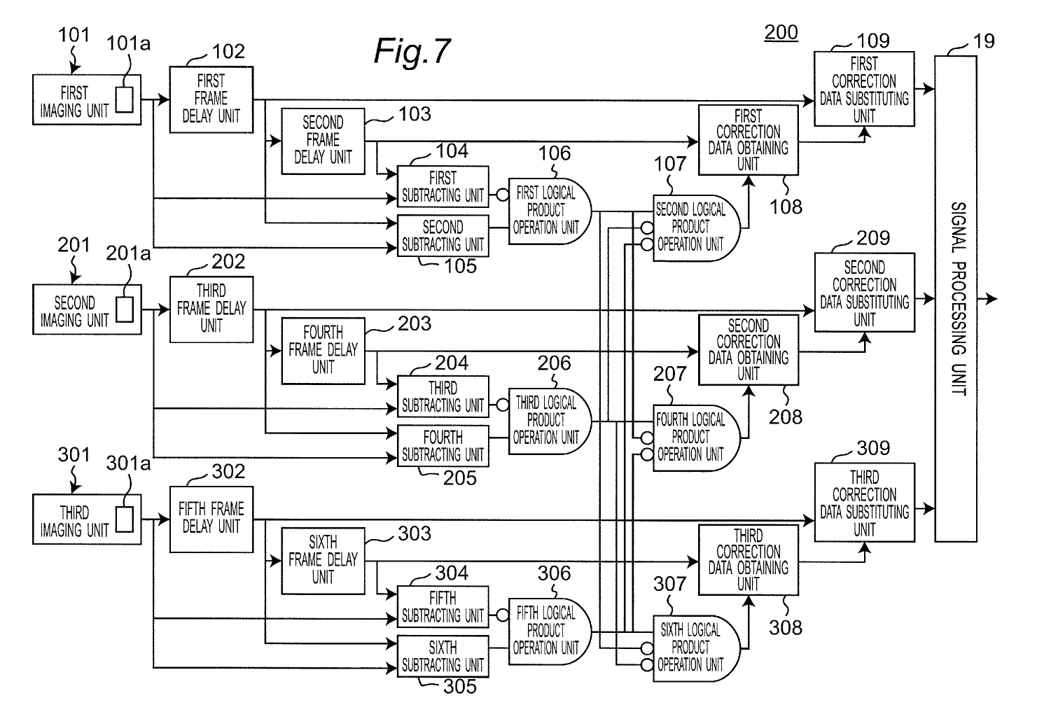

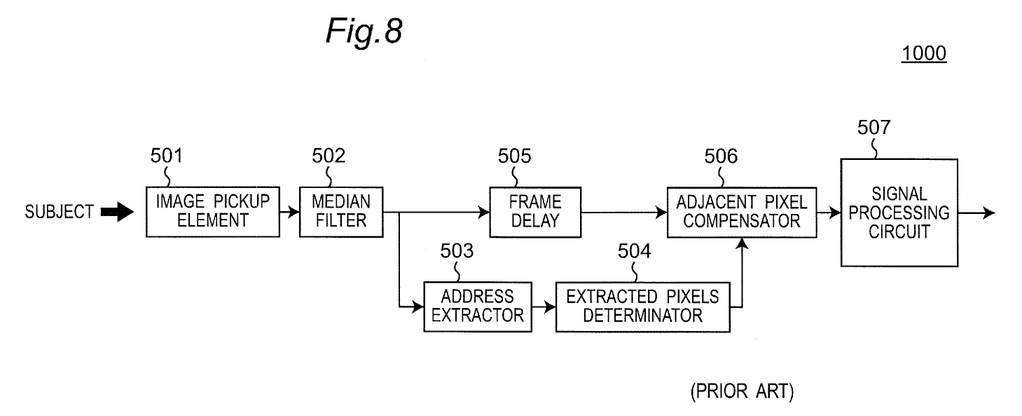

FIG. 7 is a block diagram illustrating a configuration of an image pickup apparatus 200 according to a second embodiment. The image pickup apparatus 200 is an image pickup apparatus having an optical system (not shown) and a three-element type image pickup element. The three-element type image pickup element includes an image pickup element 101 having an sensor pixel 101a which senses light of a first color channel, an image pickup element 201 having an sensor pixel 201a which senses light of a second color channel, and an image pickup element 301 having an sensor pixel 301a which senses light of a third color channel. The optical system (not shown) includes an objective lens, a zoom lens, a diaphragm, an OIS unit, a focus lens, a prism, etc. The optical system collects light from a subject and disperses the light into respective light signals of R (Red) (first color channel), G (Green) (second color channel) and B (Blue) (third color channel). The subject light dispersed into R, G and B is incident on the image pickup elements 101, 201 and 301, respectively, and is converted into image signals.

The first image pickup element 101, the second image pickup element 201, and the third image pickup element 301 output an image signal corresponding to an R component, a G component, and a B component of the subject light, respectively.

A first frame delay unit 102, a third frame delay unit 202 and a fifth frame delay unit 302 may have a configuration identical to that of the first frame delay unit 2 in the image pickup apparatus 100 according to the first embodiment.

A second frame delay unit 103, a fourth frame delay unit 203 and a sixth frame delay unit 303 may have a configuration identical to that of the second frame delay unit 3 in the image pickup apparatus 100 according to the first embodiment.

The first subtracting unit 104, a third subtraction unit 204 and a fifth subtraction unit 304 may have a configuration identical to that of the first subtracting unit 4 in the image pickup apparatus 100 according to the first embodiment. For example, the first subtracting unit 104 obtains a difference of pixel values between the third image signal and the first image signal (they both are the reference frames), and outputs the first pixel subtraction data similarly to the first subtracting unit 4. In the first subtracting unit 104, the third subtraction unit 204, and the fifth subtraction unit 304, threshold values used for generating the first pixel subtraction data may be the same as or different from the first threshold value used by the first subtracting unit 4. Further, the threshold values may be different among the first subtracting unit 104, the third subtraction unit 204, and the fifth subtraction unit 304.

The second subtracting unit 105, a fourth subtracting unit 205 and a sixth subtracting unit 305 may have a configuration identical to that of the second subtracting unit 5 in the image pickup apparatus 100 according to the first embodiment. For example, the second subtracting unit 105 obtains a difference of pixel values between the second image signal (the target frame) and the third image signal (the reference frame), and outputs the second pixel subtraction data similarly to the second subtracting unit 5. In the second subtracting unit 105, the fourth subtracting unit 205, and the sixth subtracting unit 305, threshold values used for generating the second pixel subtraction data may be the same as or different from the second threshold value used by the second subtracting unit 5. Further, the threshold values may be different among the second subtracting unit 105, the fourth subtracting unit 205, and the sixth subtracting unit 305.

The second subtracting unit 105, the fourth subtracting unit 205, and the sixth subtracting unit 305 may use the first image signal instead of the third image signal to obtain a difference from the second image signal.

A first logical product operation unit 106, a third logical product operation unit 206, and a fifth logical product operation unit 306 may have a configuration identical to that of the logical product operation unit 6 in the image pickup apparatus 100 according to the first embodiment. The first logical product operation unit 106, the third logical product operation unit 206, and the fifth logical product operation unit 306 constitute the noise pixel extraction unit which extracts a pixel (the candidate pixel) where sudden noise is likely to have occurred. For example, similarly to the logical product operation unit 6, the first logical product operation unit 106 generates and outputs data for one frame (first candidate pixel data), in which, as to the data value of respective pixels, a datum of “1” (High) is recorded for a pixel where the value of the first pixel subtraction data output from the first subtracting unit 104 is “0” and the value in the second pixel subtraction data output from the second subtracting unit 105 is “1”, and the datum of “0” (Low) is recorded for the other pixels. The third logical product operation unit 206 and the fifth logical product operation unit 306 also output second candidate pixel data and third candidate pixel data, respectively, similarly to the first logical product operation unit 106.

A second logical product operation unit 107, a fourth logical product operation unit 207, and a sixth logical product operation unit 307 constitute the noise pixel determining unit which determines with more accuracy whether the candidate pixel includes sudden noise. The second logical product operation unit 107, the fourth logical product operation unit 207, and the sixth logical product operation unit 307 are different from the logical product operation unit 6 in the image pickup apparatus 100 according to the first embodiment. The second logical product operation unit 107, the fourth logical product operation unit 207, and the sixth logical product operation unit 307 are three-input and one-output type logical product operators.

The second logical product operation unit 107 determines whether sudden noise is present on the candidate pixels of the target frame (the second image signal) based on the first candidate pixel data output from the first logical product operation unit 106, the second candidate pixel data output from the third logical product operation unit 206, and the third candidate pixel data output from the fifth logical product operation unit 306.

More specifically, the second logical product operation unit 107 generates and outputs data for one frame (first sudden noise generating pixel data), in which the data of “1” (High) and “0” (Low) are recorded. As to a data value of each pixel, a datum of “1” (High) is recorded when the value in the first candidate pixel data output from the first logical product operation unit 106 is “1” (High) and the value in the second candidate pixel data output from the third logical product operation unit 206 is “0” (Low) and the value in the third candidate pixel data output from the fifth logical product operation unit 306 is “0” (Low), and a datum of “0” (Low) is recorded in other cases. As described above, the image pickup element 101 of R channel is physically separated from the image pickup elements 201 and 301 of another color channels. For this reason, when only the pixel value of the candidate pixel of R channel in the target frame increases compared with the pixel value in the reference frame, it is determined that sudden noise has occurred in the image pickup element 101 of R channel.

Similarly to the second logical product operation unit 107, the fourth logical product operation unit 207 generates and outputs data for one frame (second sudden noise generating pixel data), in which data of “1” (High) and “0” (Low) are recorded. A datum of “1” (High) is recorded for the pixel when the value thereof in the second candidate pixel data output from the third logical product operation unit 206 is “1” (High) and the value in the third candidate pixel data output from the fifth logical product operation unit 306 is “0” (Low) and the value in the first candidate pixel data output from the first logical product operation unit 106 is “0” (Low), and a datum of “0” (Low) is recorded in other cases.

Similarly to the second logical product operation unit 107 and the fourth logical product operation unit 207, the sixth logical product operation unit 307 generates and outputs data for one frame (third sudden noise generating pixel data), in which data of “1” (High) and “0” (Low) are recorded. A datum of “1” (High) is recorded for the pixel when the value thereof in the third candidate pixel data output from the fifth logical product operation unit 306 is “1” (High) and the value in the first candidate pixel data output from the first logical product operation unit 106 is “0” (Low) and the value in the second candidate pixel data output from the third logical product operation unit 206 is “0” (Low), and a datum of “0” (Low) is recorded for the pixel in other cases.

A first correction data obtaining unit 108, a second correction data obtaining unit 208, and a third correction data obtaining unit 308 have configurations identical to each other. For example, the first correction data obtaining unit 108 recognizes a pixel where sudden noise occurs in the target frame (R channel) based on the first sudden noise generating pixel data output from the second logical product operation unit 107. The first correction data obtaining unit 108 obtains a pixel value of a pixel at the same position as the pixel where the sudden noise has occurred from the third image signal ((R channel) reference frame) output from the second frame delay unit 103 and outputs the pixel value as correction data for the pixel where sudden noise has occurred in the target frame to a first correction data substituting unit 109. The first correction data obtaining unit 108 may output the first sudden noise generating pixel data as well as the correction data to the first correction data substituting unit 109.

Similarly to the first correction data obtaining unit 108, the second correction data obtaining unit 208 recognizes a pixel where sudden noise occurs in the target frame (G channel) based on the second sudden noise generating pixel data output from the fourth logical product operation unit 207. The second correction data obtaining unit 208 obtains correction data from the reference frame (G channel) and outputs the correction data to a second correction data substituting unit 209. The second correction data obtaining unit 208 may output the second sudden noise generating pixel data as well as the correction data to the second correction data substituting unit 209.

Similarly to the first correction data obtaining unit 108 and the second correction data obtaining unit 208, the third correction data obtaining unit 308 recognizes a pixel where sudden noise occurs in the target frame (B channel) based on the third sudden noise generating pixel data output from the sixth logical product operation unit 307. The third correction data obtaining unit 308 obtains correction data from the reference frame (B channel) and outputs the correction data to a third correction data substituting unit 309. The third correction data obtaining unit 308 may output the third sudden noise generating pixel data as well as the correction data to the third correction data substituting unit 309.

The first, second, and third correction data obtaining units (108, 208 and 308) each may recognize a pixel where sudden noise occurs in the respective target frames based on the first, second, and third candidate pixel data, instead of recognizing a pixel where sudden noise occurs in the respective target frames based on the first, second, and third sudden noise generating pixel data, respectively and may perform the following operations.

The first correction data substituting unit 109, the second correction data substituting unit 209, and the third correction data substituting unit 309 have configurations identical to each other. For example, the first correction data substituting unit 109 corrects the sudden noise in the second image signal ((R channel) target frame) input from the first frame delay unit 102 using the correction data input from the first correction data obtaining unit 108. The first correction data substituting unit 109 may operate so that, among the candidate pixels, the unit 109 corrects a pixel value of the second image signal ((R channel) target frame) on the pixel that has been determined as including sudden noise by the second logical product operation unit 107 and the unit 109 does not correct a pixel value of the second image signal on the pixel that has been determined as not including sudden noise by the second logical product operation unit 107. The second correction data substituting unit 209 and the third correction data substituting unit 309 also may operate in a similar manner.

Similarly to the first correction data substituting unit 109, the second correction data substituting unit 209 corrects the sudden noise in the second image signal ((G channel) target frame) input from the third frame delay unit 202 using the correction data input from the second correction data obtaining unit 208.

Similarly to the first correction data substituting unit 109 and the second correction data substituting unit 209, the third correction data substituting unit 309 corrects the sudden noise in the second image signal ((B channel) target frame) input from the fifth frame delay unit 302 using the correction data input from the third correction data obtaining unit 308.

The first correction data substituting unit 109, the second correction data substituting unit 209, and the third correction data substituting unit 309 each may correct the pixel values of the candidate pixels indicated in the first, second, and third candidate pixel data by substituting those values, respectively.

The signal processing unit 19 executes various necessary image processes for the image pickup apparatus 200 such as gamma correction, white balance correction, scratch correction, etc.

on the image signals output from the first, second, and third correction data substituting units (109, 209 and 309) and outputs the image signal.

In the image pickup apparatus 200 according to the second embodiment, the sudden noise that occurs in the three-element type image pickup elements (101, 201 and 301) can be accurately removed, and a satisfactory image can be obtained.

Unlike the image pickup apparatus 100 according to the first embodiment, the image pickup apparatus 200 according to the second embodiment can detect the sudden noise without the comparison with adjacent pixels. Accordingly, the sudden noise that has occurred only in a single pixel can be detected.

Also in the image pickup apparatus 100 according to the first embodiment, when a median filter is provided, the sudden noise that has occurred only in a single pixel can be removed.

In the description of the second embodiment, the three-element type image pickup element has physically separate three image pickup elements. However, the three-element type image pickup element may be composed of a physically single image pickup element. Further, subject light is dispersed by a prism so that respective color channel components of the subject light are extracted. However, a color filter that temporally changes its transmission spectrum may be provided on the image pickup element instead of the prism, so that the respective color channel components of the subject light may be received by the single image pickup element in a temporally-switching manner.

In the second embodiment, the image pickup element is a three-element type image pickup element which receives dispersed light of three colors that has been dispersed from the subject light using respective separate image pickup element pieces. However, the image pickup element is not limited to the three-element type image pickup element. The image pickup element may be composed of arbitral number of image pickup element pieces. The second embodiment can be applied to the case where the sensor pixels that sense light of different colors and receive the substantially identical subject light are not adjacent to each other on the image pickup element, such as the case where the pixels are separated by a several number of sensor pixels or more.

The image pickup apparatus 200 does not have to have all of or at least any one of the second logical product operation unit 107, the fourth logical product operation unit 207 and the sixth logical product operation unit 307. In this case, the first, second, and third correction data obtaining units (108, 208 and 308), and the first, second, and third correction data substituting units (109, 209 and 309) may recognize the pixels where the data value “1” is recorded in the first, second, and third candidate pixel data output from the first, third, and fifth logical product operation units (106, 206 and 306) as pixels including sudden noise, and may perform the pixel corrections.

Detailed configurations and detailed operations of the respective components forming the image pickup apparatus 200 according to the second embodiment can be suitably modified without deviating the scope of the present invention.

In the image pickup apparatus 100 according to the first embodiment, the extracted pixel discriminating unit 7 compares a target frame's pixel value of a candidate pixel with a target frame's pixel value of a sensor pixel which is adjacent to the pixel that has output the pixel value of the candidate pixel so as to determine whether the candidate pixel includes sudden noise or not accurately (FIG. 6). In contrast, in the image pickup apparatus 200 according to the second embodiment, the second, fourth, and sixth logical product operation units (107, 207 and 307) check whether or not the pixel values of the sensor pixels of the different colors which correspond to the sensor pixel that has output the pixel value of the candidate pixel vary between pixel values of the target frame and the reference frame so as to determine whether the candidate pixel includes sudden noise or not accurately. In other words, the image pickup apparatuses 100 and 200 according to the embodiments can determine with more accuracy whether or not the sudden noise has occurred on the candidate pixel based on the target frame's pixel value of another sensor pixel that has a predetermined relationship with the sensor pixel that has output the pixel value of the candidate pixel in the target frame.

The sensor pixel that has the predetermined relationship with the sensor pixel that has output the pixel value of the candidate pixel is a sensor pixel that senses a different color from color which the sensor pixel that has output the pixel value of the candidate pixel senses and receives subject light substantially identical to that the sensor pixel concerning the candidate pixel receives. Further, that a certain sensor pixel receives the subject light substantially identical to that the sensor pixel concerning the candidate pixel receives means that a difference between the subject light received by the certain sensor pixel and the subject light received by the sensor pixel concerning the candidate pixel is within several pixels at a light receiving surface of an image pickup element. Preferably, the difference is equal to or less than one pixel of the sensor pixel arrangement on the light receiving surface of the image pickup element.

In the first and second embodiments, two frames positioned before and after the target frame with regard to the imaging timing are used as the reference frames, but the number of the reference frames is not limited to two. Three or more frames positioned before and after the target frame with regard to the imaging timing may be used as reference frames. The reference frames only have to include one frame positioned before the target frame with regard to the imaging timing and one frame positioned after the target frame with regard to the imaging timing. The reference frame does not have to be the frame positioned immediately before or immediately after the target frame with regard to the imaging timing.

In the first embodiment, the sensor pixels arrangement of the image pickup element 1a is the Bayer arrangement, but not limited thereto.

In the first and second embodiments, the image pickup element senses light of RGB colors, but not limited thereto. The image pickup element only have to sense light of two different colors at least. Further, the combination of two colors is not limited to the combination of two from the RGB.

The frame delay units (2, 3, 102, 103, 202, 203, 302 and 303), the subtracting units (4, 5, 104, 105, 204, 205, 304 and 305), the logical product operation units (6, 106, 107, 206, 207, 306 and 307), the extracted pixel discriminating unit (7), the correction data obtaining units (108, 208 and 308), the correction data substituting units (8, 109, 209 and 309), and the signal processing units (9 and 19) in the first and second embodiments can be implemented using a dedicated signal processing apparatus (processor), or a general-purpose signal processing apparatus (processor) and a program running on such a processor.

The image pickup apparatus according to the embodiments has excellent performance in detecting sudden noise, and is useful as a image pickup apparatus of a still camera, a video camera, etc.

What is claimed is:

1. An image pickup apparatus comprising:
an image pickup element operable to output an image signal, the image pickup element having a plurality of sensor pixels;
a noise pixel extraction unit operable to extract a candidate pixel as a candidate of a pixel that includes sudden noise in a second image signal based on a first image signal captured at a first timing, the second image signal captured at a second timing after the first timing, and a third image signal captured at a third timing after the second timing by the image pickup element; and
a correction unit operable to correct a pixel value of at least one candidate pixel in the second image signal extracted by the noise pixel extraction unit.

2. The image pickup apparatus according to claim 1, further comprising a noise pixel determining unit operable to determine whether or not the candidate pixel extracted by the noise pixel extraction unit includes the sudden noise based on a pixel value of the second image signal that is output from a second sensor pixel in the image pickup element, the second sensor pixel receiving subject light substantially identical to that a first sensor pixel which outputs the pixel value of the candidate pixel receives and sensing light of a different color from that the first sensor pixel senses,
wherein the correction unit corrects a pixel value of a pixel which is involved in the candidate pixel extracted by the noise pixel extraction unit and is determined as including the sudden noise in the second image signal by the noise pixel determining unit.

3. The image pickup apparatus according to claim 2, wherein the correction unit does not correct a pixel value of a pixel which is involved in the candidate pixel extracted by the noise pixel extraction unit and is determined as not including the sudden noise in the second image signal by the noise pixel determining unit.

4. The image pickup apparatus according to claim 2, wherein the image pickup element is a single-chip type image pickup element in which sensor pixels that sense light of different colors are regularly arranged, and
wherein the second sensor pixel is adjacent to the first sensor pixel in the single-chip type image pickup element.

5. The image pickup apparatus according to claim 2, wherein
the image pickup element is a three-element type image pickup element which includes a plurality of image pickup element pieces, the plurality of image pickup element pieces being physically separated by each color that the image pickup element piece senses,
the second sensor pixel is included in the image pickup element piece physically separated from the image pickup element piece on which the first image pickup element is disposed.

6. The image pickup apparatus according to claim 1, wherein the noise pixel extraction unit extracts the candidate pixel as the candidate of the pixel that includes the sudden noise in the second image signal based on a result of pixel-by-pixel comparison between the first image signal and the third image signal and a result of pixel-by-pixel comparison between the second image signal and the first or third image signal.

7. The image pickup apparatus according to claim 1, wherein the noise pixel extraction unit extracts the candidate pixel as the candidate of the pixel that includes the sudden noise in the second image signal based on a result of pixel-by-pixel comparison between the first image signal and the second image signal and a result of pixel-by-pixel comparison between the second image signal and the third image signal.

8. A processor, comprising a noise pixel extraction unit operable to input a first image signal, a second image signal, and a third image signal and extract a candidate pixel as a candidate of a pixel that includes sudden noise in the second image signal based on the first image signal, the second image signal, and the third image signal, the first, second, and third image signals being captured by an image pickup element having a plurality of sensor pixels, the first image signal being captured at a first timing, the second image signal being captured at a second timing after the first timing, and the third image signal being captured at a third timing after the second timing.

9. The processor according to claim 8, further comprising a noise pixel determining unit operable to determine whether or not the candidate pixel extracted by the noise pixel extraction unit includes the sudden noise based on a pixel value of the second image signal that is output from a second sensor pixel in the image pickup element, the second sensor pixel receiving subject light substantially identical to that a first sensor pixel which outputs the pixel value of the candidate pixel receives and sensing light of a different color from that the first sensor pixel senses.

10. An image capturing method, comprising:
inputting a first image signal captured at a first timing, a second image signal captured at a second timing after the first timing, and a third image signal captured at a third timing after the second timing by an image pickup element having a plurality of sensor pixels;
extracting a candidate pixel as a candidate of a pixel that includes sudden noise in the second image signal based on the first image signal, the second image signal, and the third image signal; and
correcting a pixel value of at least one candidate pixel in the second image signal extracted at the extracting.

11. The image capturing method according to claim 10, further comprising:
determining whether or not the candidate pixel extracted at the extracting includes the sudden noise based on a pixel value of the second image signal that is output from a second sensor pixel in the image pickup element, the second sensor pixel receiving subject light substantially identical to that a first sensor pixel which outputs the pixel value of the candidate pixel receives and sensing light of a different color from that the first sensor pixel senses,
wherein, at the correcting, a pixel value of a pixel which is involved in the candidate pixel and is determined at the determining as including the sudden noise in the second image signal is corrected.

12. A computer-readable medium having stored thereon computer executable instructions which, when executed by a computer, cause the computer to perform:
inputting a first image signal captured at a first timing, a second image signal captured at a second timing after the first timing, and a third image signal captured at a third timing after the second timing by an image pickup element having a plurality of sensor pixels;
extracting a candidate pixel as a candidate of a pixel that includes sudden noise in the second image signal based on the first image signal, the second image signal, and the third image signal; and
correcting a pixel value of at least one candidate pixel in the second image signal extracted at the extracting.

13. The computer-readable according to claim 12 which, when executed by a computer, further cause the computer to perform determining whether or not the candidate pixel extracted at the extracting includes the sudden noise based on a pixel value of the second image signal that is output from a second sensor pixel in the image pickup element, the second sensor pixel receiving subject light substantially identical to that a first sensor pixel which outputs the pixel value of the candidate pixel receives and sensing light of a different color from that the first sensor pixel senses,
wherein, at the correcting, a pixel value of a pixel which is involved in the candidate pixel and is determined at the determining as including the sudden noise in the second image signal is corrected.
